(19) United States
(12) Patent Application Publication
(10) Pub. No.: US 2002/0064263 A1
(43) Pub. Date: May 30, 2002

(54) System and method for automatically and dynamically configuring dialing properties of a telephone

(75) Inventors: Gerald F. McBrearty, Austin, TX (US); Johnny M. Shieh, Austin, TX (US)

Correspondence Address: Edmond A. DeFrank, 20145 Via Medici, Northridge, CA, 91326, US

(73) Assignee: International Business Machines Corporation

(21) Appl. No.: 09/726,273

(22) Filed: Nov. 30, 2000

(51) Int. Cl. H04M 1/56; H04M 15/06; H04M 3/00

(52) U.S. Cl. 379/142.01; 379/352; 379/354

(57) ABSTRACT

The present invention is embodied in a system and method for automatically configuring dialing properties of a telephone, such as a landline or mobile telephone. In general, the present invention allows a user's most often called outgoing and received incoming numbers to be easily dialed, even as the user's calling patterns change. This is accomplished by automatically and dynamically tracking, sorting, organizing and displaying the most frequently called and received telephone numbers without requiring preprogramming of the telephone. Namely, as a number is dialed less or more often, it's place in the organized hierarchy is represented.

### BACKGROUND OF THE INVENTION

1. Field of the Invention

The present invention relates in general to telephones and in particular to a system and method for automatically and dynamically configuring dialing properties of a telephone.

2. Related Art

Telecommunication products allow users to communicate with others almost anywhere in the world. One type of telecommunication product is a telephonic device. Telephonic devices can include landline based telephones and mobile telephones (such as cellular telephones). Landline based telephones include both conventional corded telephones and cordless telephones. The corded telephones typically use 900 megahertz or 2.4 gigahertz frequencies, and thus have limited range from the base. Mobile telephones, which are becoming increasingly popular and ubiquitous communication devices, provide mobile two-way communication using a duplex radio that acts like a regular telephone within any area that contains cells for carrying the signal.

Most types of telephones have several functions and support many different types of features including caller identification, conference calling, call waiting, call forwarding, voice mail, etc. For example, caller identification is a function that detects and displays an incoming phone number, and sometimes the identification of the person associated with the incoming number. Caller identification call be incorporated directly into the telephone itself, or it can be a stand-alone device that attaches externally to the telephone.

Another popular function includes allowing a user to preprogram a certain telephone number with the ability to recall that number with a touch of one or several buttons. This function is commonly referred to as a “speed dialing” function. Speed dial is designed to allow a user to personalize his/her telephone by allowing easy dialing of his/her most commonly called or most desirable telephone numbers.

However, currently, most systems that use caller identification and speed dial functions can create inconvenience for the user. For instance, although a user can initiate automatic “call backs” of an unanswered incoming calls that were detected by a caller identification function, the “call backs” are not organized or sorted for the user based on the importance of the incoming call. Further, the speed dialing function is lacking because preprogramming speed dial buttons can be a tedious and boring task. In addition, the user must remember the speed dial button or combination of buttons to be depressed to activate the preprogrammed number.

Therefore, what is needed is a system and method for automatically configuring dialing properties of a telephone. What is further needed is a system and method that automatically and dynamically tracks, sorts, organizes and displays the most frequently called and received telephone numbers without requiring manual preprogramming of the telephone.

### SUMMARY OF THE INVENTION

To overcome the limitations in the prior art described above, and to overcome other limitations that will become apparent upon reading and understanding the present specification, the present invention is embodied in a system and method for automatically and dynamically configuring dialing properties of a telephone, such as a landline or mobile telephone.

In general, the present invention allows a user's most often called outgoing and received incoming numbers to be easily dialed, even as the user's calling patterns change. This is accomplished by automatically and dynamically tracking, sorting, organizing and displaying the most frequently called and received telephone numbers without requiring preprogramming of the telephone. Namely, as a number is dialed or as a number is received less or more often, its place in the organized hierarchy is represented accordingly.

In particular, a memory device and a caller identification function are associated with the telephone, preferably as built-in devices and functions. The memory device tracks and stores each phone number that is dialed as an outgoing call as well as each phone that is received as an incoming call with the caller identification function. The identification of the tracked phone number is included in the memory storage of the tracked phone number to build a history of incoming and outgoing numbers.

After tracking each phone number, a sorting function is performed against all the numbers in the memory, for instance, a bubble sort could be used. From this, the most frequently called and received numbers are organized as single touch sensitive buttons and displayed to the user, preferably as a set of dynamically changing “hot” buttons. For example, the “hot” buttons can be displayed on a liquid crystal display screen that is touch sensitive (such as a touch screen faceplate) and automatically and dynamically changeable based on the frequency of the incoming or outgoing call.

The present invention as well as a more complete understanding thereof will be made apparent from a study of the following detailed description of the invention in connection with the accompanying drawings and appended claims.

### BRIEF DESCRIPTION OF THE DRAWINGS

Referring now to the drawings in which like reference numbers represent corresponding parts throughout:

FIG. 1 is a general block diagram showing an overview of the present invention.

FIG. 2 is a diagram showing the storage and addresses of the memory device of the present invention.

FIG. 3 is a detailed flow chart of illustrating a working example of the present invention.

### DETAILED DESCRIPTION OF THE INVENTION

In the following description of the invention, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### I. General Overview of the Components

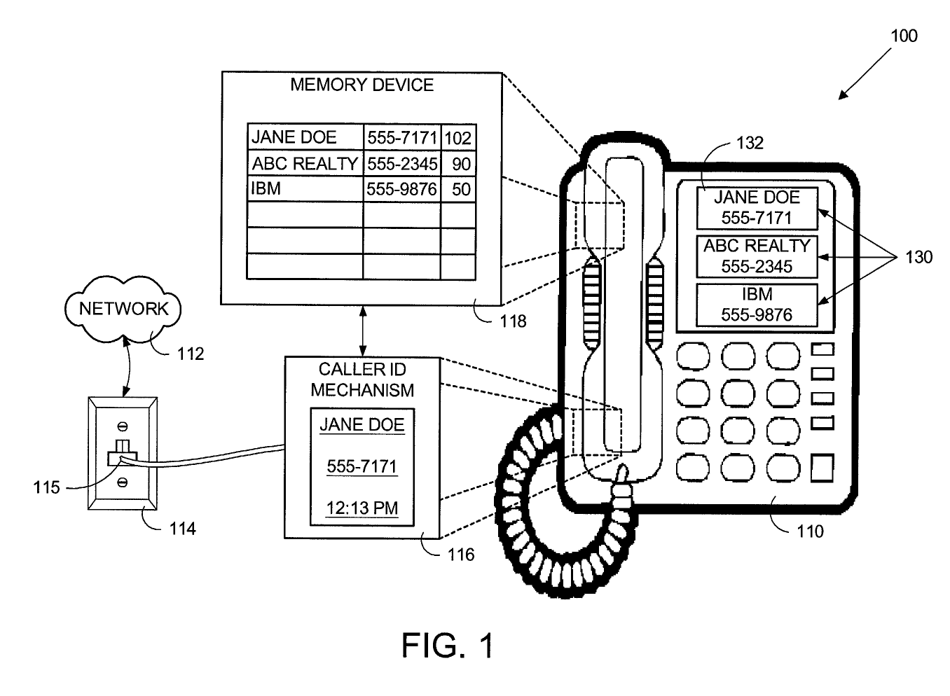

FIG. 1 is a general block diagram showing an overview of the present invention. The system 100 is adapted to automatically and dynamically configure dialing properties of a telephone. In general, the system 100 includes telephone 110 connected to a network 112. The telephone 110 can be any suitable telephone, such as a landline corded telephone, a cordless telephone or a mobile (such as a cellular) telephone. The network 112 can be any suitable network, including a Public Switched Telephone Network (PSTN), cellular network, a local area network (LAN) or the Internet. However, for simplistic purposes, the network 112 is depicted in FIG. 1 as a PSTN (not shown) connected to the telephone 110 via a telephone wall outlet 114 with a standard RJ11 telephone jack 115.

The telephone 110 includes a caller identification (caller ID) mechanism 116 and a memory device 118. The caller ID mechanism 116 and the memory device 118 can be external devices, but are preferably internal devices integrated with the telephone 110, as shown in FIG. 1. The telephone system 100 configures the most often called outgoing and received incoming telephone numbers as “hot” buttons 130, even as a user's calling patterns change. Namely, system 100 automatically and dynamically tracks, sorts, organizes and displays the most frequently called and received telephone numbers without requiring manual preprogramming of the telephone. As such, as a number is dialed or as a number is received less or more often, its place in the organized hierarchy is represented accordingly.

### II. Details of the Components and Operation

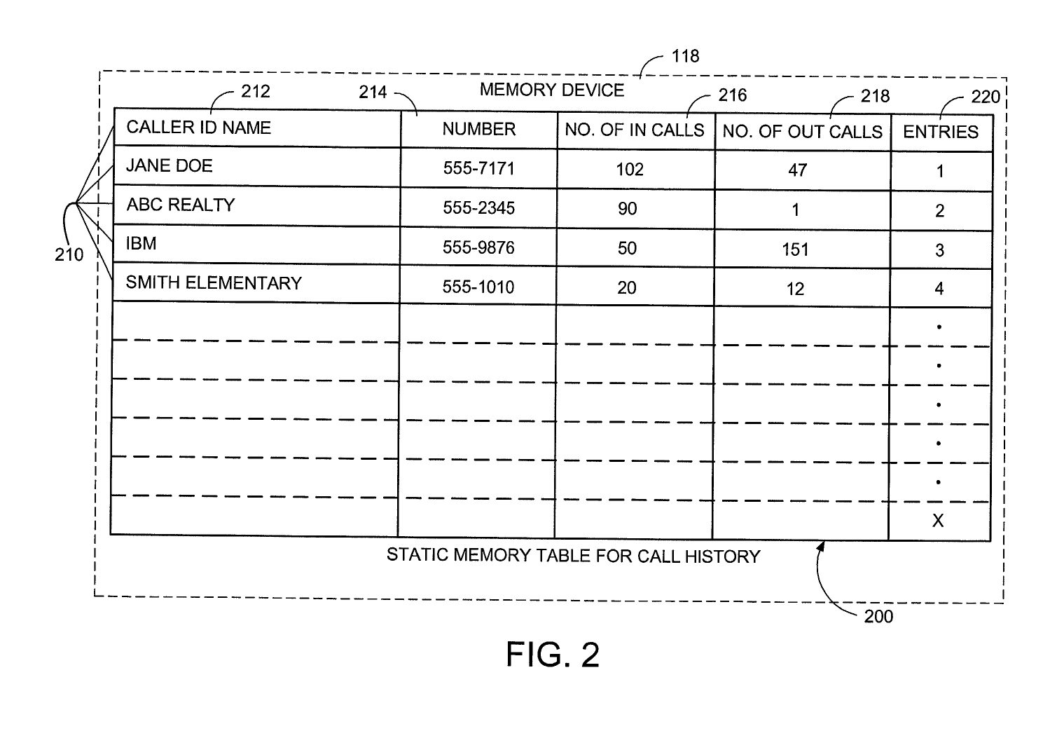

FIG. 2 is a diagram showing the storage and addresses of the memory device of the present invention. In particular, the caller ID mechanism 116 of FIG. 1 tracks each phone number that is dialed as an outgoing call as well as each phone that is received as an incoming call. The memory device 118 stores the tracked phone numbers and their associated indicia are included in the memory device of the tracked phone number.

The user or the factory can configure the memory device and define parameters such as the maximum number of entries, which entries to discard to conserve memory based on frequency of calls and time lapsed. For example, if several phone numbers have been called or received less than a predefined number, after a predefine time lapses, those numbers can be discarded from the memory devices. With this arrangement, a history of incoming and outgoing numbers is automatically and efficiently built.

For instance, as shown in FIG. 2, the history can be categorically arranged in static memory 200 of memory device 118 as individual records 210. Each record represents either an incoming call or an outgoing call. Also, each record 210 can have numerous fields associated with it. As an example, some fields could include a caller ID name field 212, which would store that name that is officially associated with the phone number, a number field 214, which would store the number, an incoming frequency field 216, which would store the number of times a certain number was received, an outgoing frequency field 218, which would store the number of times the user called a certain number and the number of entries 220. It should be noted that the incoming and outgoing frequency fields 216, 218 could be combined into a single field.

After each phone number is tracked by the caller ID mechanism 116, a sorting function is performed against all the numbers in the memory device 118. Any suitable sorting function can be used to sort frequency of calls, such as a bubble sort. The sorting function sorts the phones numbers and determines the most frequently called and received numbers and lists N of them as single touch buttons displayed to the user. The sorting is preferably performed every time a phone call is made or received. Thus, the single touch buttons dynamically change as the user's telephone usage changes. This allows automatic and dynamic updating of the single touch buttons based on frequency usage of the telephone without requiring manual preprogramming and manual updating.

Referring back to FIG. 1, the single touch buttons can be “hot” buttons 130 that are displayed on a liquid crystal display (LCD) 132 screen that is touch sensitive (shown in FIG. 1 as a touch screen faceplate). As discussed above, the LCD screen 132 is automatically and dynamically changeable based on the frequency of the incoming or outgoing calls. In addition, although it is not necessary, the user, if desired, can preprogram the LCD screen 132. Also, FIG. 1 shows the LCD touch screen with 3 entries, however, any number of entries can be displayed on the LCD touch screen. Further, there can be two sets of buttons, one set for frequently dialed incoming calls and another for frequently received outgoing calls.

### III. Working Example

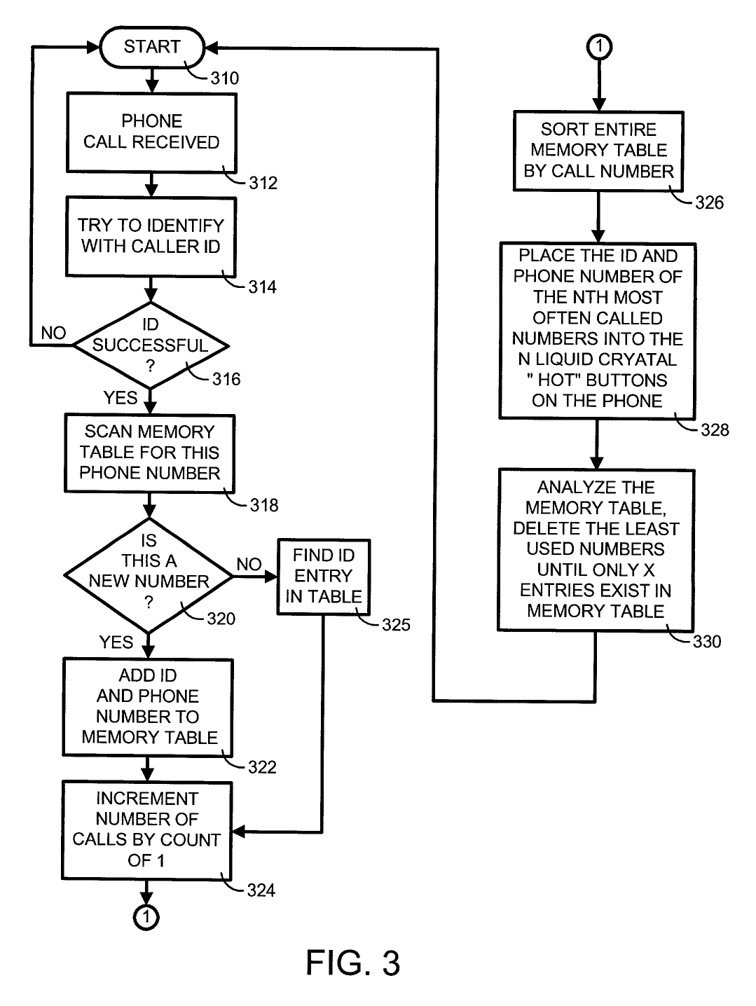

FIG. 3 is a detailed flow chart of illustrating a working example of the present invention. The system first starts (step 310). Second, when a phone call is received (step 312), the system attempts to identify what the phone number is with the caller ID mechanism (step 314). Third, it is determined whether the caller ID is successful (step 316). If the caller ID mechanism is unsuccessful at identifying the call, the system returns (step 310). If the caller ID mechanism is successful at identifying the call, a table memory is scanned for the particular number (step 318).

Fourth, it is determined whether the identified number is a new number (step 320). If it's a new number, the number is added to the memory table (step 322) and then the total number of calls in the table for each number can be tracked in any suitable way, for example by incrementing the number of calls associated with the identified number by one (step 324). If from (step 320) the number is not a new number, then the system looks for the identified number in the table (step 325) and then increments the number of calls associated with the identified number by one (step 324).

Next, the entire memory table can be sorted in any suitable manner. For example, each number in the table can be sorted based on the number of times that particular number is identified (step 326). The identification of the Nth most often called number is placed into programmable speed dial memory, such as N liquid crystal “hot” buttons on the phone (step 328). The memory table is then analyzed and organized, for example, so that the least used numbers are deleted until only X user configurable number of entries exist in the memory table (step 330).

The foregoing description of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for automatically configuring dialing properties of a telephone, comprising:
tracking incoming calls received by the telephone;
determining the frequency of each incoming call and indicia about each tracked call; and
displaying a list of the most frequently called incoming calls in a predefined sorted order.

2. The method of claim 1, wherein displaying the list of most frequently called incoming calls includes providing a user accessible button that allows dialing of each record of the list.

3. The method of claim 1, further comprising tracking outgoing calls dialed by the telephone.

4. The method of claim 2, further comprising determining the frequency of each outgoing call.

5. The method of claim 4, further comprising displaying the most frequently called outgoing calls.

6. The method of claim 3, further comprising using a bubble sort method for determining the most frequently incoming and outgoing calls in a sorted order.

7. The method of claim 3, further comprising deleting incoming and outgoing calls with the least amount of frequency.

8. An electronic management system for a telephone, comprising:
an identification mechanism that tracks incoming calls received by the telephone;
a memory device that determines the frequency of each incoming call and stores the incoming calls; and
a display device that displays a list of the most frequently called incoming calls.

9. The electronic management system of claim 8, further comprising a touch sensitive device that allows a user to access each incoming call.

10. The electronic management system of claim 9, wherein the touch sensitive device is an electronic button.

11. The electronic management system of claim 9, wherein the touch sensitive device is a touch sensitive liquid crystal display screen.

12. The electronic management system of claim 8, wherein the memory device tracks outgoing calls dialed by the telephone.

13. The electronic device of claim 12, further comprising a sort processor of the memory device that determines the frequency of each incoming and outgoing call for providing the display device with the most frequently incoming and outgoing calls in a sorted order.

14. The electronic management system of claim 8, wherein the memory device includes a programmable area to allow the user to preprogram preferences and storage criteria.

15. The electronic device of claim 13, wherein the sort processor uses a bubble sort method for providing the display device with the most frequently incoming and outgoing calls in a sorted order.

16. A telephone for automatically managing incoming and outgoing calls, comprising:
an identification mechanism that tracks incoming calls and outgoing calls received by the telephone;
a memory device that determines the frequency of each incoming and outgoing call and stores indicia about each call;
a display device that displays a list of the most frequently called incoming and outgoing calls; and
a touch sensitive device that allows a user to access the list of incoming and outgoing calls.

17. The telephone of claim 16, wherein the touch sensitive device is a touch sensitive liquid crystal display screen.

18. The telephone of claim 16, further comprising a sort processor of the memory device that determines the frequency of each incoming and outgoing call for providing the display device with the most frequently incoming and outgoing calls in a sorted order.

19. The telephone of claim 18, wherein the sort processor uses a bubble sort method for providing the display device with the most frequently incoming and outgoing calls in a sorted order.

20. The telephone of claim 16, wherein the memory device includes a programmable area to allow the user to preprogram preferences and storage criteria.
